(19) United States
(12) Patent Application Publication
(10) Pub. No.: US 2020/0051481 A1
(43) Pub. Date: Feb. 13, 2020

(54) BURN-IN RESISTANT DISPLAY SYSTEMS

(71) Applicant: N2 Imaging Systems, LLC, Irvine, CA (US)

(72) Inventors: David Michael Masarik, Newport Beach, CA (US); Joseph Carlson, Foothill Ranch, CA (US)

(21) Appl. No.: 16/101,320

(22) Filed: Aug. 10, 2018

(51) Int. Cl. G09G 3/20; G09G 5/02; H04N 1/60

(52) U.S. Cl. CPC G09G 3/2003; G09G 2300/0452; H04N 1/60; G09G 5/028

(57) ABSTRACT

A method of displaying an image on a pixel array includes, at a pixel array having a plurality of pixels with subpixels, assigning one or more subpixels of a pixel as an image subpixel to display image data only and assigning one or the more of the subpixels as a symbology subpixel to display symbology data only. When data received at the pixel array includes image data the image data is display by the image subpixels only, and not by the symbology subpixels, to limit degrading in imagery displayed once the symbology subpixels exhibit burn-in. Image display systems and digital weapon sights are also described.

### BACKGROUND OF THE INVENTION

### 1. Field of the Invention

The present disclosure relates to electronic display systems, and more particularly to burn-in resistant image display systems and methods of displaying images on pixel arrays, such as images with symbology and imagery on digital weapon sights.

### 2. Description of Related Art

Displays are commonly used to display images. In some displays a ghost image can develop over time on the screen, typically due to presentation of a single image over a period time in a common location, like in displays that present a background image or screen saver for extended time intervals. Such image persistency is generally referred to as screen burn-in, and appears as discoloration that once present competes with currently displayed images or graphics.

Screen burn-in is caused by non-uniform usage of pixels of the display, particularly, by constant or semi-static display of a certain image or graphics for a prolonged period of time. For example, in digital weapon sights where a reticle is displayed in conjunction with a sight picture for extended periods of time, the reticle image can persist once power is removed from the display or the digital weapon sight configured for image display only. The ghost image of the reticle can reduce the quality of imagery presented thereafter. In some digital weapon sights burn-in can limit the usefulness of the digital weapon sight, potentially limiting the service life of the digital weapon sight.

Such conventional methods and systems have generally been considered satisfactory for their intended purpose. However, there is still a need in the art for improved digital weapon sights, image display systems, and methods of displaying images on pixel arrays. The present disclosure provides a solution for this need.

### SUMMARY OF THE INVENTION

A method of displaying an image on a pixel array includes, at a pixel array having a plurality of pixels with subpixels, assigning one or more subpixels of a pixel as an image subpixel to display image data only and assigning one or the more of the subpixels as a symbology subpixel to display symbology data only. When data received at the pixel array includes image data the image data is display by the image subpixels only, and not by the symbology subpixels, to limit degrading in imagery displayed once the symbology subpixels exhibit burn-in.

In certain embodiments, displaying the image data can include displaying the image data monochromatically. Displaying the image data can include displaying image data of scene collected through a digital weapon sight. Symbology data can be displayed with the symbology subpixel and the symbology data can be not displayed with image subpixel when data received at the pixel includes symbology data. Displaying the symbology data can include displaying the symbology data monochromatically. The symbology data can include, for example, a reticle overlay for a digital weapon sight or other digital weapon sight symbology.

In accordance with certain embodiments, the method can include receiving image data at the pixel, displaying image data received at the pixel with the image subpixel, and not displaying image data received at the pixel with the symbology subpixel. Symbology data can be received at the pixel, the symbology data received at the pixel can be displayed with the symbology subpixel, and symbology data received at the pixel can be not displayed with the image subpixel.

It is also contemplated that, in accordance with certain embodiments, both symbology data and image data can be received at the pixel. The symbology data received at the pixel can be displayed with the symbology subpixel. The image data received at the pixel can be displayed with the image subpixel. The image data and the symbology data can both be displayed monochromatically. The image data can be image data of a scene collected through a digital weapon sight. The symbology data can include a reticle overlay. It is also contemplated that the reticle overlay can be burned into the symbology subpixel and the image subpixel retained in an unburned state subsequent to burning-in the image of the reticle overlay in the symbology subpixel.

An image display system includes a pixel array having a plurality of pixels with subpixels and a control module. The control module is operatively connected to the pixel array and is disposed in communication with a memory having instructions recorded on it that, when read by the control module, causes the control module to assign one or more subpixel of a pixel as an image subpixel and assign one or more subpixel of the pixel as a symbology subpixel such that, when data received at the pixel includes image data, the image data is displayed with the image subpixel and is not displayed with the symbology subpixel.

In certain embodiments the pixel array can be a monochromatic pixel array. Subpixels of the pixel array can be filterless. The instructions can cause the controller to receive symbology data at the pixel array, display the symbology data received by the pixel with the symbology subpixel, and not display the symbology data received by the pixel with the image subpixel. The instructions can cause the controller to receive both symbology data and image data at the pixel array, display the symbology data received by the pixel with the symbology subpixel, and display the image data received by the pixel with the imagery subpixel.

It is contemplated that that pixels of pixel array can be organic light emitting diodes. Each pixel can include a 2×2 subpixel matrix. Each pixel of the pixel array can include a first image subpixel, a first symbology subpixel laterally adjacent to the first image subpixel, a second image subpixel adjacent to the first symbology subpixel and diagonally offset from the first image subpixel, and a second symbology subpixel. The second symbology subpixel can be laterally adjacent to the second image subpixel, adjacent to the first image subpixel, and diagonally offset from the first symbology subpixel.

A digital weapon sight includes an image display system as described above. A housing supports the image display system and is configured for mounting on a weapon. An image sensor is supported by the housing and disposed in communication with the controller to acquire image data of scene within a field of view of the digital weapon sight. In certain embodiments a reticle overlay is burned into the symbology subpixels and the image subpixels remain unburned.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a perspective view of an exemplary embodiment of digital weapon sight constructed in accordance with the present disclosure, showing a display system supported within the digital weapon sight for displaying an image of a scene with an overlay;

FIG. 2 is a schematic view of the digital weapon sight of FIG. 1, showing a controller operatively associated with the display system for presenting image data and symbology data as an image to the user;

FIG. 3 is schematic view of a pixel of a pixel array of the display system shown in FIG. 1, showing subpixels of the pixel received to display image data and subpixels received to display symbology data according to an exemplary embodiment;

FIGS. 4-7 are schematic views of the pixel array of the display system of FIG. 1, showing image subpixels and symbology subpixels displaying image data and symbology data in both a burned-in state and an unburned state, respectively; and

FIG. 8 is a block diagram of a method of displaying an image on a display system, showing steps of the method.

### DETAILED DESCRIPTION OF THE PREFERRED EMBODIMENTS

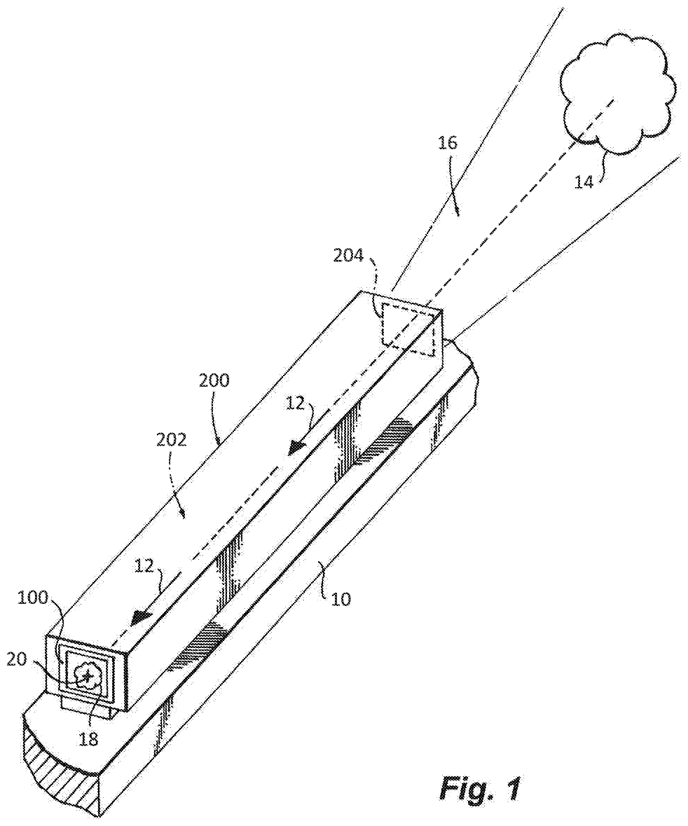

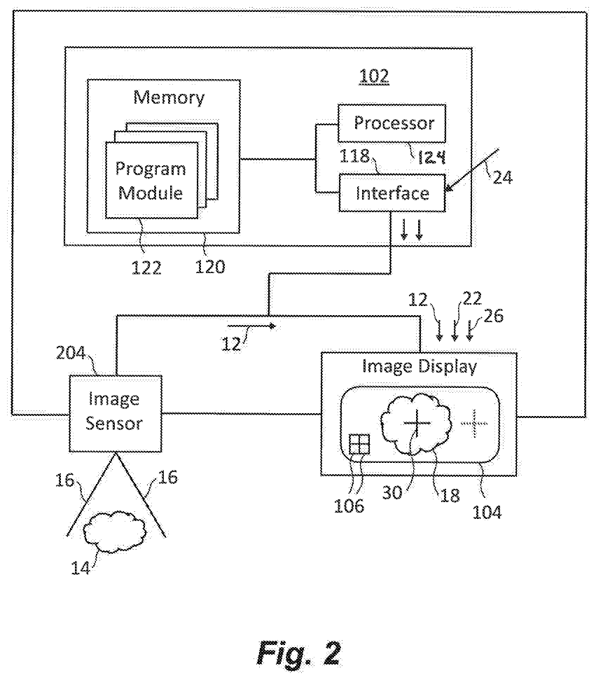

Reference will now be made to the drawings wherein like reference numerals identify similar structural features or aspects of the subject disclosure. For purposes of explanation and illustration, and not limitation, a partial view of an exemplary embodiment of an display system in accordance with the disclosure is shown in FIG. 1 and is designated generally by reference character 100. Other embodiments of image display systems, digital weapon sights, and methods of displaying images on pixel arrays in accordance with the disclosure, or aspects thereof, are provided in FIGS. 2-8, as will be described. The systems and methods described herein can be used for display devices susceptible to burn-in, such as digital weapon sights employing organic light-emitting diode (OLED) devices, though the present disclosure is not limited to digital weapon sights or to OLED devices in general.

Referring to FIG. 1, a digital weapon sight 200 is shown. Digital weapon sight 200 includes image display system 100, a housing 202, and an image sensor 204. Housing 202 supports image display system 100 with a controller 102 (shown in FIG. 2) and image sensor 204, and is configured for mounting on a weapon, e.g., weapon 10. Image sensor 204 is disposed in communication with controller 102 to acquire image data 12 of a scene 14 from a field of view 16 of image display system 100. Image data 12 is in turn presented to a user by image display system 100 as an image 18 of scene 14. Symbology 20, e.g., a reticle overlay, can be presented with image data 12 in image 18 using symbology data 22 provided to image display system 100. Examples of suitable digital weapon sights include MDOG® and MADOG™ digital weapon sights, available from N2 Imaging Systems, LLC of Irvine, Calif.

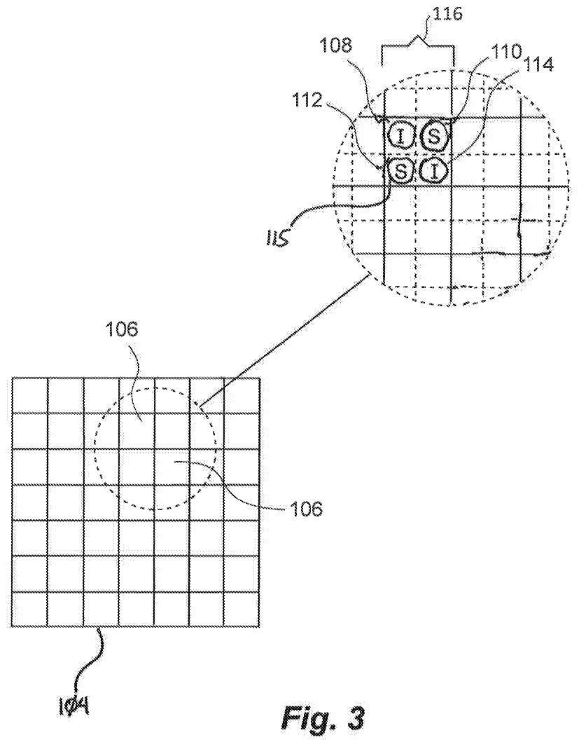

With reference to FIG. 2, image display system 100 is shown. Image display system 100 includes a pixel array 104. Pixel array 104 includes a plurality of pixels 106. Pixels 106 are arranged on a grid and include a plurality of subpixels, e.g., subpixels 108-114 (shown in FIG. 3). Each of subpixels 108-114 includes an OLED device 115 (shown in FIG. 3). In certain embodiments the OLED devices are unfiltered, i.e., do not have a color filter optically coupled to the respective OLED device, pixel array 104 thereby being a monochromatic (greyscale) pixel array. The plurality of subpixels 108-114 are operatively associated with a controller 102, and thereby receive image data 12, symbology data 22, and subpixel assignment 26 for image data 12 and symbology data 22 for generating image 18 using pixel array 104 for presentation to a user on image display system 100.

One challenge with certain types of pixels is burn-in. Burn-in is a condition where certain pixels in a display do not light up as brightly as other, non-burned in, pixels when a common voltage is applied to the burned-in and non-burned in pixels. OLED devices can be particularly prone to burn-in after prolonged time intervals of remaining in an on-state. In the case of image display system where an image is displayed on the display system for extended time intervals, such as symbology overlays displayed on digital weapon sights, burn-in can cause ghosting, which is a condition wherein the symbology overlay persists as a dimming of the burned-in pixels on the screen when the associated symbology signal is removed from the pixel array. To limit the effect of burn-in on imagery presented to a user with pixel array 104, image display system 100 assigns selected subpixels of respective pixels 106 to display image data only, e.g., image data 12, and assigns other selected subpixels of respective pixels 106 to display symbology data only, e.g. symbology data 22. This causes each pixel to display image data notwithstanding burn-in associated with display of symbology by the pixel.

With reference to FIG. 3, pixel array 104 and pixels 106 is shown according to an exemplary embodiment. Pixels 106 (indicated with solid outline) each include a 2×2 subpixel matrix 116. Each subpixel matrix 116 includes four (4) subpixels 108-114 (indicated with dashed outline) with an OLED device 115, OLED device 115 schematically shown in FIG. 2 with a circle for purposes of clarity.

In the illustrated exemplary embodiment two subpixels of each pixel are dedicated to displaying symbology data and two subpixels of each pixel are dedicated to displaying image data. Dedication is accomplished via assignment data 26 (shown in FIG. 2), which dedicates via the assignment data 26 two of subpixels 108-114 to displaying image data 12 (shown in FIG. 2) and two of the subpixels 108-114 to displaying symbology data 22 (shown in FIG. 2). For example, assignment data 26 can cause pixel 106 to utilize an upper left subpixel (relative to the drawing sheet) a first image subpixel 108, utilize an upper right subpixel as a first symbology subpixel 110 (laterally adjacent to first image subpixel 108), utilize a lower left subpixel as a second symbology subpixel 112 (adjacent to first symbology subpixel 110 and diagonally offset from the first image subpixel 108), and utilize a lower right subpixel as a second image subpixel 114. Second image subpixel 114 is laterally adjacent to second symbology subpixel 112, is adjacent (below) to first symbology subpixel 110, and is diagonally offset from first image subpixel 108 on pixel 2×2 subpixel matrix 116.

Being assigned as image subpixels, first image subpixel 108 and second image subpixel 114 receive and display image data 12 only. Being assigned as symbology subpixels, first symbology subpixel 110 and second symbology subpixel 112 receive and display symbology data 22 only. The assignment of the respective subpixels dedicates the subpixels with respect to the type of data received at the pixel displayed by subpixels of the pixel. The dedication of subpixels of each pixel to displaying image data and displaying symbology data in turn limits the effect that burn-in has (once manifest) on display system performance as the burn-in is limited to the subpixel dedicated to displaying symbology data while the image subpixels remain unaffected. The ghost image associated with the burn-in is therefore less discernable to the user and image data still presented by the pixel having the burn-in. In the illustrated exemplary embodiment pixel 106 is assigned two image subpixels, i.e., first image subpixel 108 and second image subpixel 114, and two symbology subpixels, i.e., first symbology subpixel 110 and second symbology subpixel 112. This is for illustration purposes only as those of skill in the art will appreciate that other subpixel assignment and dedication arrangements are possible and remain within the scope of the present disclosure.

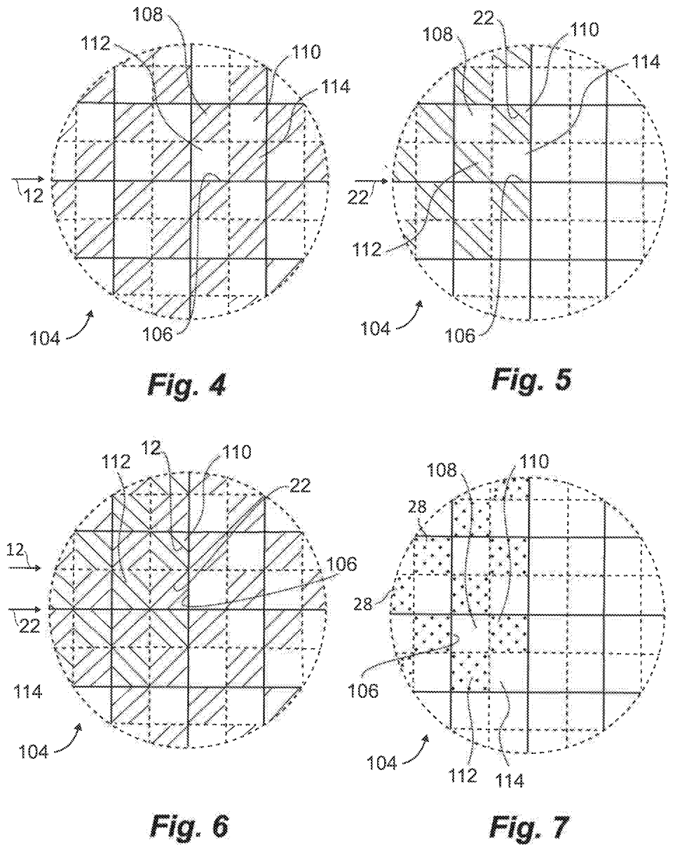

With reference to FIGS. 4-7, a portion of pixel array 104 is shown displaying image data 12, symbology data 22, both image data 12 and symbology data 22, and displaying no image data 12 and no symbology data 22 once burn-in 28 is manifest, respectively. As shown in FIG. 4, when pixel array 104 receives image data 12 only, first image subpixel 108 and second image subpixel 114 only display image data 12. First symbology subpixel 110 and second symbology subpixel 112 do not display image data 12. As shown in FIG. 5, when pixel array 104 receives symbology data 22 only, only first symbology subpixel 110 and second symbology subpixel 112 of respective pixels 106 display symbology data 22. First image subpixel 108 and second image subpixel 114 do not display symbology data 22. As shown in FIG. 6, when pixel array 104 receives both image data 12 and symbology data 22, first image subpixel 108 and second image subpixel 114 display image data 12 only while first symbology subpixel 110 and second symbology subpixel 112 display symbology data 22 only.

As a consequence, when prolonged display of symbology data 22 results in pixel burn-in 28, burn-in 28 limited to subpixels assigned to display symbology data 22. This is shown in FIG. 7, wherein subpixels of pixels utilized to display symbology data 22 for time intervals sufficient to manifest burn-in display burn-in 28. As will be appreciated by those of skill in the art in view of the present disclosure, the burned-in pixels remain capable of displaying image 12 due to image subpixels not manifesting burn-in. In certain embodiments the assignment of first image subpixel 108, first symbology subpixel 110, second symbology subpixel 112, and second image subpixel 114 is akin to the assignment of color steps to subpixels in Bayer pattern pixels, with the difference that color filters of the Bayer pattern subpixels are removed (e.g., stripped) such that pixels are filterless and that controller 102 is programmed assign image data 12 and symbology data 22 in place of color steps to specific subpixels with pixels 106 of pixel array 104.

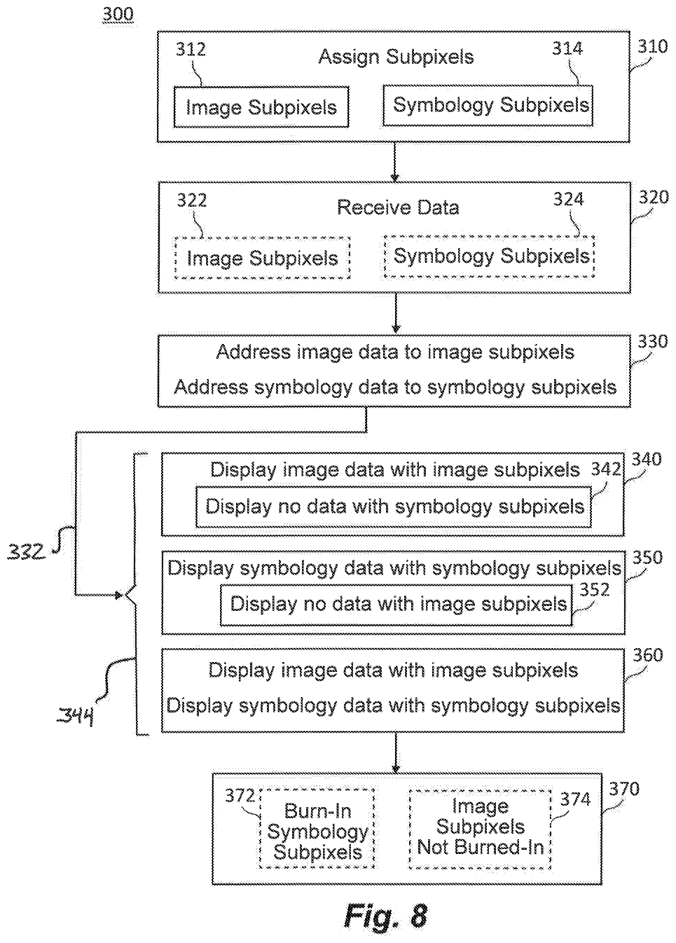

With continuing reference to FIG. 2, controller 102 includes a processor 124, a user interface 118, and a memory 120. User interface 118 is disposed in communication with processor 124 and is configured to receive a user input 24, e.g., a ‘display symbol’ input. Memory 120 is disposed in communication with processor 124 and has a plurality of program modules 122 recorded on it that, when read by processor 124, cause processor 124 to execute certain operations. Among those operations are operations of a method 300 (shown in FIG. 8) of displaying an image on a pixel array, e.g., pixel array 104 (shown in FIG. 3), as will be described.

Processor 124 is operatively associated with image sensor 204 and image display system 100 to display imagery 18 and symbology 20 (shown in FIG. 1) using image data 12, received from image sensor 204, and symbology data 22. Symbology data 22 can be stored data resident on memory 120, such as a reticle overlay 30, with pixel assignments on pixel array 104. Symbology data 22 can also be calculated using data resident on memory 120, such as distance and/or azimuth symbology, with pixel assignments on pixel array 104. The pixel assignment can be fixed or dynamic, as suitable for an intended application, burn-in being delayed (or prevented entirely) using the systems and methods described herein.

The instructions recorded on program modules 122 cause controller 102 to, among others thing, receive image data 12 at pixel 106, display image data 12 received at pixel 106 with image subpixel 112/114, and to not display image data 12 received at pixel array 104 with symbology subpixel 108/110. The instructions recorded on program modules 122 also cause controller 102 to receive symbology data 22 at pixel 106, display symbology data 22 received at pixel 106 with symbology subpixel 108/110, and to not display symbology data 22 received at pixel 106 with image subpixel 112/114. Further, it is contemplated that the instructions recorded on program modules 122 cause controller 102 to receive both symbology data 22 and image data 12 at pixel 106, display symbology data 22 with symbology subpixel 108/110, and display image data 12 received at pixel 106 with imagery subpixel 112/144.

With reference to FIG. 8, method 300 of displaying an image on a pixel array, e.g., pixel array 104 (shown in FIG. 3), is shown. Method 300 includes assigning at least one subpixel of a pixel, e.g., pixel 106 (shown in FIG. 3), to display a different type of data than another subpixel of the pixel, as shown with box 310. For example, one or more subpixels of the pixel array can be assigned as image subpixels, e.g., first image subpixel 108 (shown in FIG. 3) and/or second image subpixel 114 (shown in FIG. 3), as shown with box 312. One or more of the subpixels can be assigned as symbology subpixels, e.g., first symbology subpixel 110 (shown in FIG. 3) and second symbology subpixel 112, as shown with box 314. For each pixel in the pixel array, selected subpixels are assigned as image subpixels, as shown with box 322.

Data is received at the image array, as shown in box 320. It is contemplated that the data can include image data, e.g., image data 12 (shown in FIG. 1), as shown with box 322. It is also contemplated that the data can include symbology data, e.g., symbology data 22 (shown in FIG. 2), as shown with box 324. In certain embodiments receiving data at the image array includes receiving both image data and symbology data, as shown with both box 322 and box 324, in association with one or more common pixel. As shown with box 330, it is contemplated that data can be address to both image subpixels and symbology subpixels of the image array.

When data received at the pixel array includes image data the image data is displayed on the subpixels assigned as image subpixels and the image data is not displayed on the subpixels assigned as symbology subpixels, as shown with box 340 and box 342. When data received at the pixel array includes symbology data the symbology data is displayed on the symbology subpixel and the symbology data is not displayed in the image subpixel, as shown with box 350 and box 352. When data received at the pixel array includes both image data and symbology data, the image data and the image data is displayed on the image subpixel and the symbology data is displayed on the symbology subpixel, as shown with box 360.

Displaying the image data can include displaying image data of scene, e.g., scene 14 (shown in FIG. 1) collected through a digital weapon sight, e.g., digital weapon sight 200 (shown in FIG. 1), as shown with arrow 332. Displaying the image data can include displaying the image data monochromatically, as shown with bracket 344. Displaying the symbology data can include displaying the symbology data monochromatically, as also shown with bracket 344. As will be appreciated, displaying the image data and the symbology data can include displaying both the image data and the symbology data monochromatically, as additionally shown with bracket 344. The symbology data displayed by the pixel array can, for example, a reticle overlay 30 for a digital weapon sight or other digital weapon sight symbology, as shown in FIG. 2. It is contemplated that the method can include burning-in a ghost image, e.g. with burn-in 28 (shown FIG. 7), in the symbology subpixel of certain pixels of the pixel array while image subpixels of the certain pixels remain unburned, as shown with boxes 370-374.

In certain embodiments a display having pixels with unfiltered white subpixels and subpixels with color filters, such as red/green/blue filters. The image data can be assigned to the subpixels having red/green/blue filters and the symbology data assigned to the unfiltered white subpixel. This produces a full color image on the display with a white symbology overlay where, once the unfiltered white subpixel is burned-in, the image data is still displayed by the pixel on a color display. Alternatively, the image data can be displayed with the unfiltered white subpixel and the symbology data displayed with one or more of the red/green/blue subpixels. This produces a monochromatic image with full color symbology overlay on a color display.

OLED micro displays used in some night vision devices can exhibit burn-in when a static image is displayed for prolonged period of time statically on the display. This can be particularly true for weapon sight devices, where certain types of symbolic overlays are persistently displayed, e.g., reticles, distance measurements, and azimuth indicators by way of non-limiting example. In embodiments described herein devices requiring only a monochrome display a color OLED display is converted to monochrome by removing the color filters typically included with the OLED pixels. This creates a subpixel array where each subpixel is a monochrome subpixel. In certain embodiments, e.g., embodiments having a 2×2 subpixel array, one pair of diagonal pixels are used for image data (e.g., imagery or video) and the other pair of diagonal are used to display symbolic overlays (or insertions). While the pixels used for the symbolic overlay can still exhibit burn-in they do not display image or video data, extending display service life.

The methods and systems of the present disclosure, as described above and shown in the drawings, provide for methods of displaying images on pixel arrays, image display systems, and digital weapon sights with superior properties including extended service life prior to the image persistence becoming noticeable on the display system. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A method of displaying an image on a pixel array, comprising:
at a pixel array having a plurality of pixels with subpixels,
assigning a subpixel of a pixel as an image subpixel;
assigning a subpixel of the pixel as a symbology subpixel; and
displaying image data with the image subpixel and not displaying the image data with the symbology subpixel when data received at the pixel array includes image data.

2. The method as recited in claim 1, wherein displaying the image data includes displaying the image data monochromatically.

3. The method as recited in claim 1, wherein displaying the image data includes displaying image data of scene collected through a digital weapon sight.

4. The method as recited in claim 1, further comprising displaying symbology data with the symbology subpixel and not displaying the symbology data with the image subpixel when data received at the pixel includes symbology data.

5. The method as recited in claim 3, wherein displaying the symbology data includes displaying the symbology data monochromatically.

6. The method as recited in claim 3, wherein the symbology data includes a reticle overlay for a digital weapon sight.

7. The method as recited in claim 1, further comprising:
receiving image data at the pixel array;
displaying the image data received by the pixel with the image subpixel; and
not displaying the image data received by the pixel with the symbology subpixel.

8. The method as recited in claim 1, further comprising:
receiving symbology data at the pixel array;
displaying the symbology data received by the pixel with the symbology subpixel; and
not displaying the symbology data received by the pixel with the image subpixel.

9. The method as recited in claim 1, further comprising:
receiving symbology data and image data at the pixel array;
displaying the symbology data received by the pixel with the symbology subpixel; and
displaying the image data received by the pixel with the imagery subpixel.

10. The method as recited in claim 9, wherein one of the symbology data and the image data are displayed on a red/green/blue filtered subpixel of the pixel, wherein the other of the symbology data are displayed on an unfiltered white pixel.

11. The method as recited in claim 9, wherein symbology data and image data are monochromatic, wherein displaying the image data includes displaying image data of scene collected through a digital weapon sight, and wherein the symbology data includes a reticle overlay.

12. The method as recited in claim 9, further comprising:
burning-in an image of a reticle overlay in the symbology subpixel; and
retaining the image subpixel in an unburned state subsequent to burning-in the image of the reticle overlay in the symbology subpixel.

13. An image display system, comprising:
a pixel array having a plurality of pixels with subpixels;
a control module operatively connected to the pixel array and disposed in communication with a memory having instructions recorded on it that, when read by the control module, causes the control module to:
assign a subpixel of a pixel as an image subpixel;
assign a subpixel of the pixel as a symbology subpixel;
display image data with the image subpixel and not display the image data with the symbology subpixel when data received at the pixel includes image data.

14. The image display system as recited in claim 13, wherein the pixel array is a monochromatic pixel array, subpixels of the pixel array being filterless.

15. The image display system as recited in claim 13, wherein the plurality of pixels of the pixel array each include subpixels with organic light emitting diode devices.

16. The image display system as recited in claim 13, wherein each pixels includes:
a first image subpixel;
a first symbology subpixel laterally adjacent to the first image subpixel;
a second image adjacent to the first image subpixel and diagonally offset from the first image subpixel; and
a second symbology subpixel laterally adjacent to the second image subpixel and adjacent the first image subpixel, the second symbology subpixel diagonally offset from the first symbology subpixel.

17. The image display system as recited in claim 13, wherein the instructions recorded on the memory further cause the controller to:
receive image data at the pixel array;
display the image data received by the pixel with the image subpixel; and
not display the image data received by the pixel with the symbology subpixel.

18. The image display system as recited in claim 13, wherein the instructions recorded on the memory further cause the controller to:
receive symbology data at the pixel array;
display the symbology data received by the pixel with the symbology subpixel; and
not display the symbology data received by the pixel with the image subpixel.

19. The image display system as recited in claim 13, wherein the instructions recorded on the memory further cause the controller to:
receive symbology data and image data at the pixel array;
display the symbology data received by the pixel with the symbology subpixel; and
display the image data received by the pixel with the imagery subpixel.

20. A digital weapon sight, comprising:
an image display system as recited in claim 13;
a housing supporting the image display system and configured for mounting on a weapon; and
an image sensor supported by the housing and disposed in communication with the controller to acquire image data of scene within a field of view of the digital weapon sight.
